(19) United States
(12) Patent Application Publication
(10) Pub. No.: US 2016/0148360 A1
(43) Pub. Date: May 26, 2016

(54) FILTER PREPROCESSING CIRCUIT, OPTICAL IMAGE STABILIZER, AND METHOD OF PERFORMING OPTICAL IMAGE STABILIZATION

(71) Applicant: Samsung Electro-Mechanics Co., Ltd., Suwon-si (KR)

(72) Inventors: Kyung Rin KIM, Suwon-si (KR); Byoung Won HWANG, Suwon-si (KR); Chang Hyun KIM, Suwon-si (KR)

(73) Assignee: SAMSUNG ELECTRO-MECHANICS CO., LTD., Suwon-si (KR)

(21) Appl. No.: 14/947,186

(22) Filed: Nov. 20, 2015

(30) Foreign Application Priority Data
Nov. 25, 2014 (KR) 10-2014-0164979

(51) Int. Cl. G06T 5/20; G06T 5/00; H04N 5/232; H04N 5/262

(52) U.S. Cl. CPC G06T 5/20; H04N 5/262; G06T 5/003; H04N 5/23258; H04N 5/23264

(57) ABSTRACT

A filter preprocessing circuit includes: a determiner configured to determine, depending on a level of an offset included in a detection signal from a gyro sensor, whether or not a preprocessing operation is to be performed before the detection signal is transferred to a filter; and a remover configured to remove a portion of the offset from the detection signal during the preprocessing operation.

### CROSS-REFERENCE TO RELATED APPLICATION(S)

This application claims the benefit of Korean Patent Application No. 10-2014-0164979 filed on Nov. 25, 2014, in the Korean Intellectual Property Office, the entire disclosure of which is incorporated herein by reference for all purposes.

### BACKGROUND

1. Field

The following description relates to a filter preprocessing circuit and an optical image stabilization module that are operable to remove a direct current (DC) offset included in a detection signal from a gyro sensor.

2. Description of Related Art

Mobile devices recently released onto the market include the ability to capture images as one of several essential functions. As performance levels of mobile devices have increased, mobile devices including high performance cameras capable of capturing images having a resolution from millions of pixels to tens of millions pixels or more have been released onto the market.

However, due to limitations of mobile devices, even in cases in which a high pixel camera module is provided in a mobile device, an amount of space available for accommodating the camera module is inevitably limited.

As a result, a small lens aperture, a low image pixel amount, and the like may cause image deterioration in addition to image deterioration caused by fine motion such as external vibrations, hand-shake, or the like, at the time of capturing images.

In order to suppress the deterioration of images caused by external vibrations and obtain a clearer image, various image correction methods, such as a method of using an optical image stabilization (OIS) module that provides an optical hand-shake correction function, have been developed.

The above-mentioned OIS module may correct a distorted image by sensing fine vibrations caused by a factor such as hand-shake using a gyro sensor, and adjusting an optical path of the camera module by a mechanical method based on the sensed vibrations.

Therefore, characteristics of the gyro sensor are one of a range of important factors that may determine performance of the OIS module.

In general, human hand-shake occurs at a frequency of less than 1 Hz to a frequency of a few tens of Hz. As a result, as described in Japanese Patent Laid-Open Publication No. 2007-88829, a detection signal from the gyro sensor is quantized and then passes through a high pass filter (HPF), such that a DC offset, drift components, and the like included in the detection signal may be removed therefrom.

However, since the above-mentioned method of removing the DC offset included in the detection signal using the high pass filter may take a relatively long time, a relatively long waiting period may be required until the OIS module can be operated normally.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a filter preprocessing circuit includes: a determiner configured to determine, depending on a level of an offset included in a detection signal from a gyro sensor, whether or not a preprocessing operation is to be performed before the detection signal is transferred to a filter; and a remover configured to remove a portion of the offset from the detection signal during the preprocessing operation.

The determiner may be configured to determine whether or not the preprocessing operation is to be performed, depending on an average offset level of the detection signal.

The determiner may be configured to determine whether or not the preprocessing operation is to be performed, depending on the average offset level during a time which is set according to a set sampling rate.

The filter preprocessing circuit may further include an operation controller configured to control whether or not the filter is to be operated, depending on a determination of whether the preprocessing operation is being performed.

The operation controller may be configured to stop operation of the filter while the remover removes the portion of the offset, and the operation controller may be configured to resume the operation of the filter when the remover finishes removing the portion of the offset.

According to another general aspect, an optical image stabilization module includes: a gyro sensor configured to detect motion; a detection signal processor configured to determine, depending on a level of an offset included in a detection signal from the gyro sensor, whether or not a preprocessing operation is to be performed before filtering the offset of the detection signal, and process a signal obtained by filtering the detection signal to output the processed signal; an imager configured to capture an image; and optical path controller configured to control an optical path of the imager according to an output signal of the detection signal processor.

The detection signal processor may include: a filter preprocessing circuit configured to perform the preprocessing operation depending on the level of the offset included in the detection signal from the gyro sensor, before filtering the offset of the detection signal; a filter configured to filter an offset of a signal transferred from the filter preprocessing circuit; and a signal processing processor configured to process the filtered signal and transfer the processed filtered signal to the optical path controller.

The filter preprocessing circuit may include: a determiner configured to determine whether or not the preprocessing operation is to be performed depending on the level of the offset included in the detection signal; a remover configured to remove a portion of the offset from the detection signal according to the determining of whether or not the preprocessing operation is to be performed; and an operation controller configured to control whether or not the filter is operated depending on a determination of whether the preprocessing operation is being performed.

The determiner may be configured to determine whether or not the preprocessing operation is to be performed, depending on an average offset level of the detection signal.

The determiner may be configured to determine whether or not the preprocessing operation is to be performed, depending on the average offset level during a time which is set according to a set sampling rate.

The operation controller may be configured to stop operation of the filter while the remover removes the portion of the offset, and the operation controller is configured to resume the operation of the filter when the remover finishes removing the portion of the offset.

According to another general aspect, a method of performing optical image stabilization, includes: determining, at a determiner, a level of an offset in a detection signal received from a gyro sensor; in response to determining that the level of the offset is greater than or equal to a reference level, removing, at a remover, an amount of the offset from the detection signal; filtering, at a filter, a remaining offset in the detection signal having the amount of the offset removed; and controlling, at an optical path controller, an optical path of an imager based on the filtered detection signal in order to correct for shaking of a device associated with the gyro sensor.

The method may further include: stopping operation of the filter while the remover removes the amount of the offset; and resuming the operation of the filter when the remover finishes removing the amount of the offset.

Other features and aspects will be apparent from the following detailed description, the drawings, and the claims.

### BRIEF DESCRIPTION OF THE DRAWINGS

FIGS. 1A and 1B are graphs illustrating examples of an input signal and an output signal, respectively, of a high pass filter.

FIGS. 2A and 2B are graphs illustrating examples of an input signal and an output signal, respectively, of a high pass filter in a case in which an offset is decreased as compared to FIGS. 1A and 1B.

FIG. 3 is a schematic block diagram of a filter preprocessing circuit according to an example.

FIG. 4 is a schematic block diagram of an optical image stabilizer having a filter preprocessing circuit according to an example.

FIG. 5 is a flow chart illustrating an example of a method of operating an optical image stabilizer.

FIG. 6 is a graph illustrating an example of an output signal of a filter preprocessing circuit.

FIG. 7 is a graph illustrating an example of an output signal of a filter in a case in which the filter is operated while an offset removal operation is performed.

FIG. 8 is a graph illustrating an example of an output signal of the filter of FIG. 7 in a case in which the filter is not operated while the offset removal operation is performed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

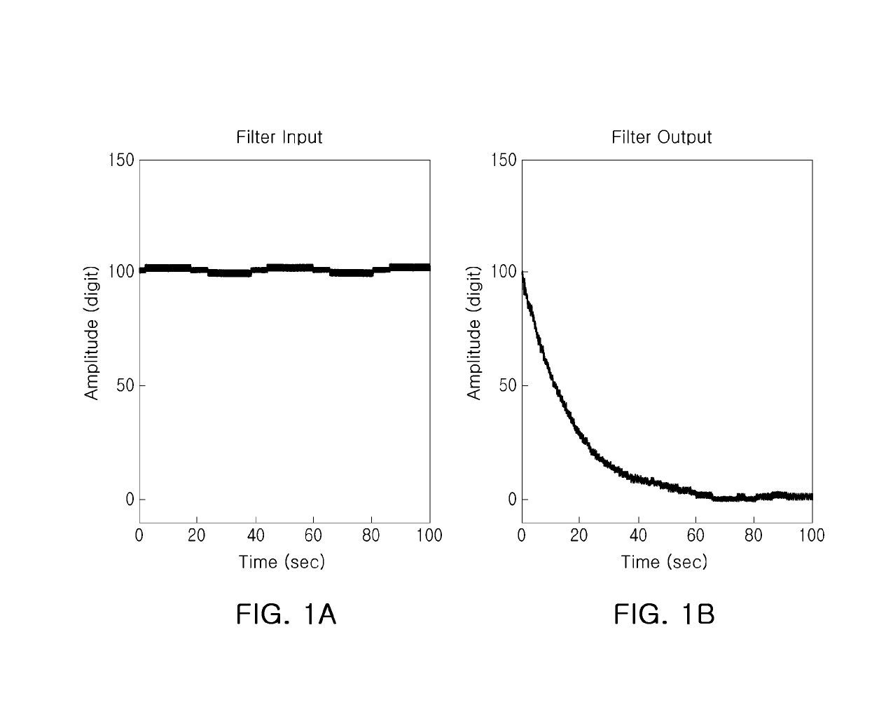

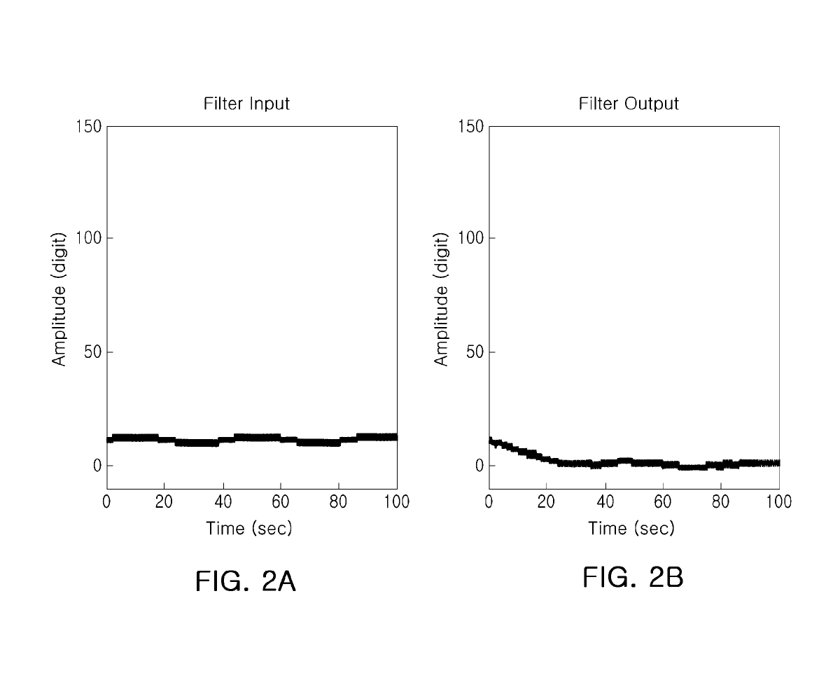

FIGS. 1A and 1B are graphs illustrating examples of an input signal and an output signal, respectively, of a high pass filter. FIGS. 2A and 2B are graphs illustrating examples of an input signal and an output signal, respectively, of the high pass filter in a case in which an offset is decreased as compared to FIGS. 1A and 1B.

FIG. 1A shows an input signal input to a high pass filter, wherein the input signal may be an output signal of a gyro sensor which has been converted into a digital signal. As shown in FIG. 1B, in a case in which the input signal includes an offset of about 100 digits and an output signal is filtered and output by the high pass filter, it may take about 70 to 80 seconds until an offset is removed (the offset falls to a level of ‘0’).

On the other hand, referring to FIGS. 2A and 2B, in a case in which the offset of an input signal input to the high pass filter is reduced to 1/10 of the offset of FIG. 1A and an output signal is filtered and output by the high pass filter, it may take about 20 to 30 seconds until the offset is removed (the offset falls to a level of ‘0’).

That is, it may be seen that a time taken for filtering the offset by the filter is significantly reduced in a case in which a preprocessing operation of removing a certain degree of offset included in the signal is performed before the signal is input to the filter. As a result, the time taken until an optical image module or a camera module including the same can be operated normally after power is applied to the optical image module or the camera module at the time of an initial start thereof may be reduced.

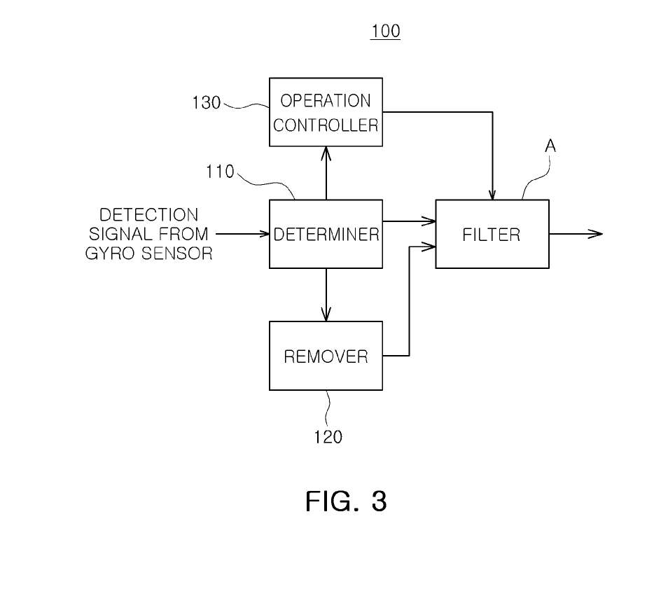

FIG. 3 is a schematic block diagram of a filter preprocessing circuit 100 according to an example.

Referring to FIG. 3, the filter preprocessing circuit 100 includes a determiner 110, a remover 120, and an operation controller 130.

The filter preprocessing circuit 100 performs a preprocessing operation capable of removing a certain degree of offset included in a device shaking detection signal (hereinafter, “detection signal”) from a gyro sensor, before the offset is filtered by a filter A. The detection signal includes information about shaking or vibration of the device (e.g., mobile device) in which the gyro sensor is disposed. The filter preprocessing circuit 100 may be implemented, for example, by a digital circuit. The digital circuit may include at least one processing unit, and may further include a memory. For example, the at least one processing unit may include at least one of a central processing unit (CPU), a microprocessor, an application specific integrated circuit (ASIC), a field programmable gate array (FPGAs), and the like, and may have a plurality of cores. For example, the memory may be a volatile memory (e.g., an RAM or the like), a non-volatile memory (e.g., an ROM, flash memory, and the like) or a combination thereof. The filter A may be, for example, a high-pass filter including, for example, a plurality of first to Nth IIR (Infinite Impulse Response) filters. In addition, the plurality of first to Nth IIR filters may be implemented in the abovementioned processing unit by programming.

The determiner 110 determines whether or not a preprocessing operation is performed, depending on a level of the offset included in the detection signal from the gyro sensor.

For example, the determiner 110 may determine that the preprocessing operation needs to be performed in a case in which the level of the offset included in the detection signal from the gyro sensor is equal to or higher than a reference level, and may determine that the preprocessing operation does not need to be performed in a case in which the level of the offset included in the detection signal from the gyro sensor is lower than the reference level.

The remover 120 may remove the offset included in the detection signal according to the determination result of the determiner 110.

An offset removal operation of the remover 120 removes at least a portion of the offset included in the detection signal in order to reduce the time taken for filtering the offset by the filter A.

The operation controller 130 may stop operations of the filter A while the remover 120 performs the offset removal operation when the determiner 110 determines that the preprocessing operation is required, depending on the level of the offset included in the detection signal from the gyro sensor.

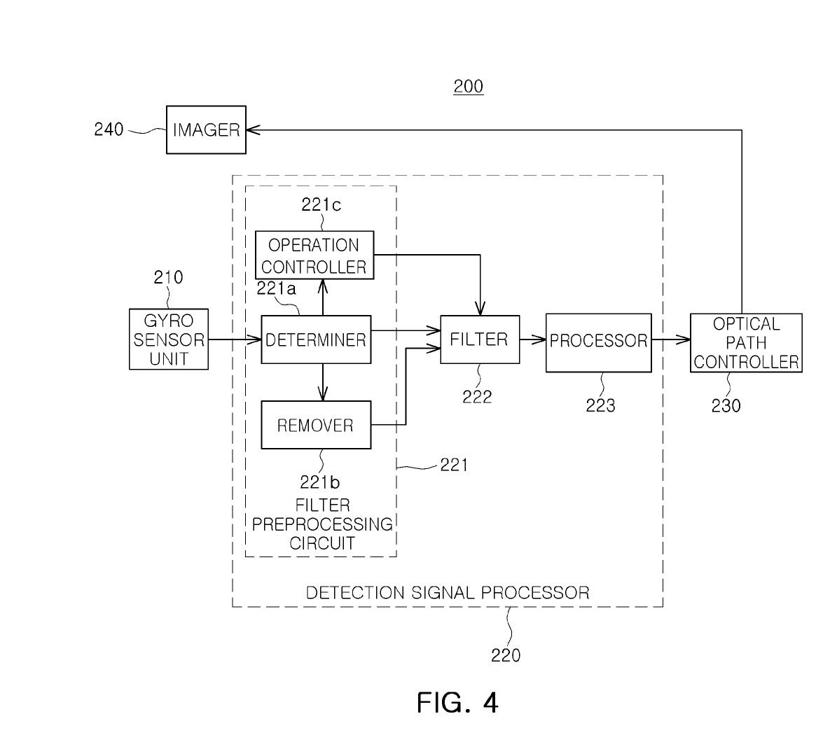

FIG. 4 is a schematic block diagram of an optical image stabilizer 200 having a filter preprocessing circuit according to an example.

Referring to FIG. 4, the optical image stabilizer 200 includes a gyro sensor 210, a detection signal processor 220, an optical path controller, and an imager 240.

The optical image stabilizer 200 may be used in the same sense as a hand-shake correction module.

The gyro sensor 210 detects shaking of a device in which the optical image stabilizer 200 is incorporated, converts a detected signal into a digital signal, and transfers the digital signal to the detection signal processor 220.

The detection signal from the gyro sensor 210 may include the offset generated by several components such as noise, drift, and the like, and may have a large amount of variation which is instantaneously present.

The detection signal processor 220 may include a filter preprocessing circuit 221, a filter 222, and signal processor 223. For example, the detection signal processor 220 may be implemented by a digital circuit.

The filter preprocessing circuit 221 may include a determiner 221a, a remover 221b, and an operation controller 221c. The filter preprocessing circuit 221 may also include at least one processing unit as illustrated in FIG. 3. The determiner 221a, the remover 221b and the operation controller 221c may be implemented in the respective abovementioned processing units by programming.
The determiner 221a may be implemented, for example, by

[if (1/N Σᵢ₌₁^{N} date (i)>threshold) is true:Enter data(N+i) into the 221b, else:Bypass data(N+i)].
The remover 221b may be implemented, for example, by

[data(N+i)=data(N+i)−1/N Σᵢ₌₁^{N} data (i)].

The operation controller 221c may be implemented, for example, by [if(N>i) is true:filter disable else:filter enable]. (where, N is an integer, and data(i) is a signal to be processed.)

The determiner 221a determines whether or not a preprocessing operation is performed, depending on a level of the offset included in the detection signal from the gyro sensor 210.

The level of the offset included in the detection signal may determine whether or not the preprocessing operation is performed using an average value of an input detection signal.

For example, a clock signal for operations of the optical image stabilizer 200 may have a frequency from a few tens of kHz to 1 kHz at minimum, and in a case in which the detection signal is sampled, based on the frequency of 1 kHz, it may be determined whether or not the level of the offset is equal to or higher than a reference level or is equal to or lower than a reference level depending on an average of data obtained by using about 100 data points, that is, the data for 10 msec.

In addition, for example, by considering efficiency of a digital circuit structure, it may be determined whether or not the level of the offset is equal to or higher than the reference level or is lower than the reference level depending on the average of the data obtained by using 128 data points.

The determiner 221 a may set the reference level as the level of the offset at which it is determined that a time taken for removing the offset included in the detection signal by the filter 222 exceeds a time allowed by the optical image module or the camera module.

Therefore, the determiner 221a may determine that the preprocessing operation is required in a case in which the level of the offset included in the detection signal is equal to or higher than the reference level, in order to allow the remover 221b to remove an amount of the offset as much as a predetermined offset removal level or more, and may transfer the detection signal to the filter 222 in a case in which the level of the offset included in the detection signal is lower than the reference level.

An offset removal level of the remover 221b may be controlled by determiner 221a.

That is, the offset removal level of the remover 221b may be determined so that the time taken for filtering the remaining offset by the filter 222 is equal to or less than the allowed time.

The signal processor 223 may perform signal processing on the detection signal filtered by the filter 222 so that the optical path controller 230 may use the detection signal, and then transfer the signal processed detection signal to the optical path controller 230. For example, the signal processor 223 may perform low-pass filtering on the detection signal filtered by the filter 222 and may then transfer an output signal to the optical path controller 230 according to an interface manner which is set with the optical path controller 230. The signal processor 223 may be a low-pass filter implemented, for example, by including, for example, a plurality of first to Nth IIR filters. In addition, the plurality of first to Nth IIR filters may be implemented in the abovementioned processing unit by programming.

The optical path controller 230 controls an optical path of the imager 240 in order to correct for hand-shake based on the detection signal from the signal processor 223. For example, the imager 240 may include a lens, an image sensor, and one or more actuators configured to control the lens and/or the sensor to capture images. The optical path controller 230 may, for example, control the movement of the lens or image sensor of the imager 240 in order to counteract motion associated with hand-shake based on the detection of the signal from the signal processor 223.

The imager 240 captures an image by varying the optical path according to the control of the controller 230.

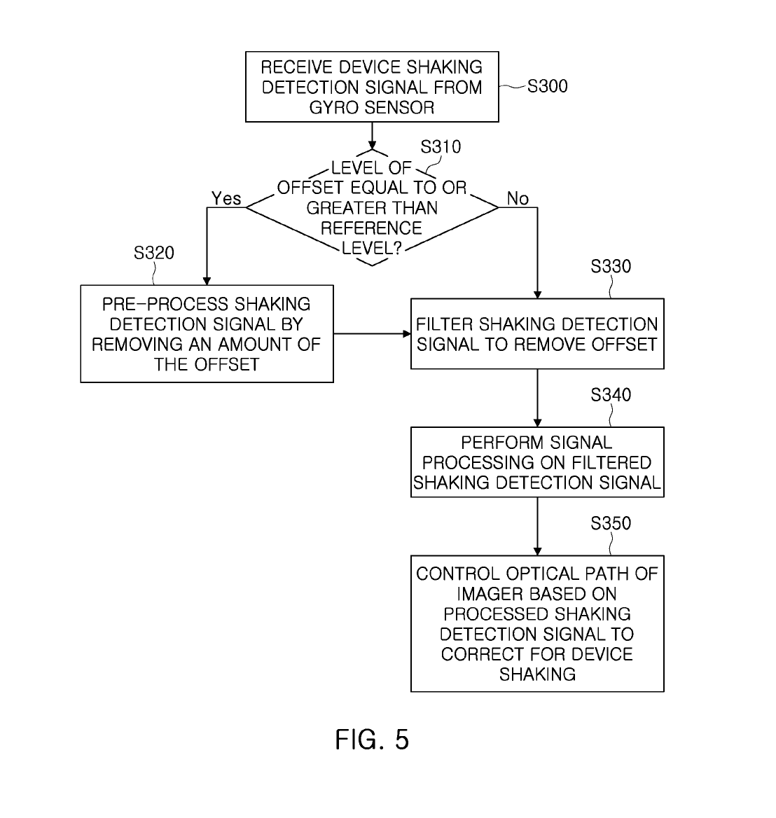

FIG. 5 is a flowchart illustrating an example method of performing optical image stabilization using the optical image stabilizer 200.

As shown in FIG. 5, in operation S300, the determiner 221a receives the detection signal from the gyro sensor 210. Thereafter, in operation S310, the determiner 221a determines the level of offset in the detection signal.

If the level of offset in the detection signal is determined to be less than the reference level in operation S310, the determiner 221a forwards the detection signal to the filter 222. Thereafter, the operation controller 221 a enables operation of the filter 222, which filters the detection signal in operation S330 by performing high-pass filtering to remove the offset from the detection signal such that the offset level of the filtered detection signal is close to ‘0.’

On the other hand, if the level of offset in the detection signal is determined to be greater than or equal to the reference level in operation S310, the determiner 221a forwards the detection signal to the remover 221. Thereafter, in operation S320, the remover 221b removes an amount of the offset from the detection signal corresponding to a removal level set by the determiner 221a, and forwards the detection signal having a reduced offset to the filter 222. During operation S320, the operation controller 221c may control the filter 222 to stop operation of the filter 222. After the operation S320, the operation controller 221c resumes operation of the filter 222, and the filter 222 filters the detection signal in operation S330 by performing high-pass filtering of the remaining offset in the detection signal such that the offset level of the filtered detection signal is close to ‘0.’

After the detection signal is filtered in operation S330, the processor S223 performs signal processing in operation S340 in order to convert the filtered detection signal to a form that is usable by the optical path controller 230. More specifically, the signal processing operation S340 may include low-pass filtering of the filtered detection signal.

Finally, in operation S350, the optical path controller 230 controls an optical path of the imager 240 in order to correct for shaking of the device based on the detection signal. For example, the optical path controller 230 may control the movement of the lens or image sensor of the imager 240 in order to counteract motion associated with the shaking of the device based on the detection of the processed signal from the signal processor 223.

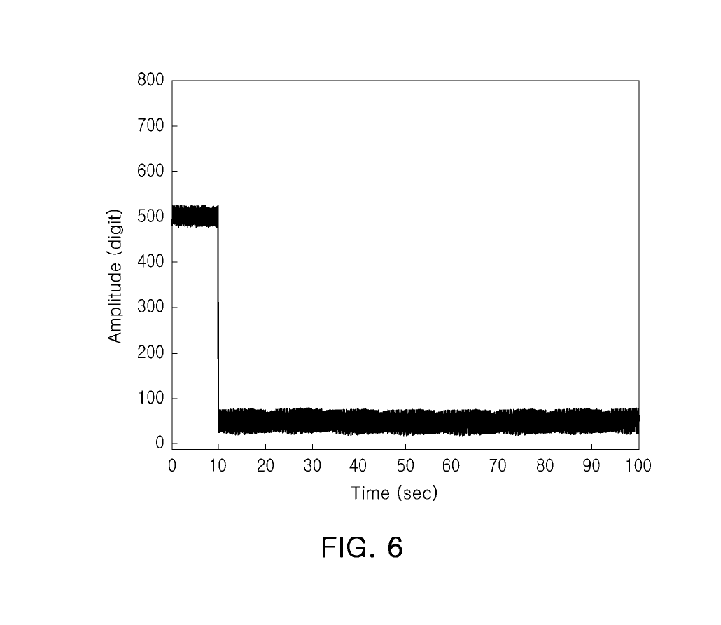

FIG. 6 is a graph illustrating an output signal of a filter preprocessing circuit according to an example.

Referring to FIGS. 4 and 6, if the level of the offset included in the detection signal input to the filter preprocessing circuit 221 is about 500 digits, the output signal from which a certain level of offset is removed by the filter preprocessing circuit 221 may have a level of the offset between 100 digits and 0 digit.

This shows that the offset may be removed to be close to 0 digits by the offset filtering operation by the filter 222, a time in which the level of the offset is decreased from 100 digits to 0 digits is shorter than a time in which the level of the offset is decreased from 500 digits to 0 digits, and consequently, the time taken for the removal of the offset included in the detection signal by the filter 222 may be less than the time allowed by the optical image module or camera module.

Meanwhile, the operation controller 221c may control whether or not the filter 222 is operated according to the control of the determiner 221a. Here, whether or not the filter 222 is operated may be controlled by stopping or resuming a supply of power necessary to drive the filter 222. That is, stopping and starting operations of the filter 222 may be controlled by stopping or resuming a supply of power necessary to drive the filter 222.

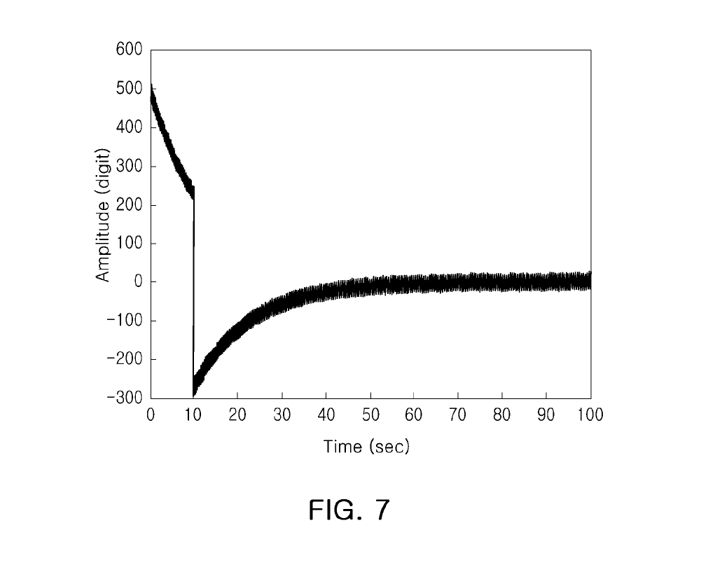

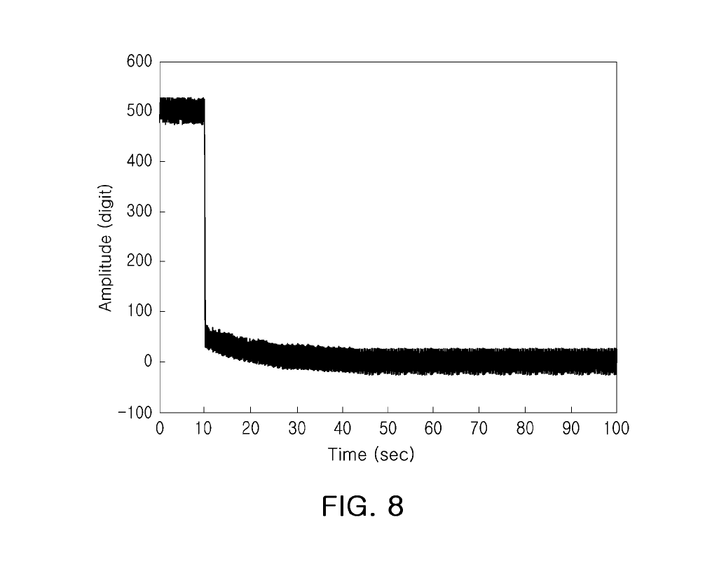

FIG. 7 is a graph illustrating an example of an output signal of a filter 222 in a case in which the filter 222 is operated while an offset removal operation is performed, and FIG. 8 is a graph illustrating an example of an output signal of a filter 222 in a case in which the filter 222 is not operated while an offset removal operation is performed.

First, referring to FIGS. 4 and 7, in a case in which the remover 221b performs the offset removal operation in response to determining that the preprocessing operation is required based on the level of the offset included in the detection signal from the gyro sensor 210, and the determiner 221a operates the filter 222 while the remover 221b performs the offset removal operation, data distortion occurs even after the preprocessing operation is performed due to a sharp change of data during the filtering operation of the filter 222. As a result, an offset removal time in the filter 222 may be increased.

Next, referring to FIGS. 4 and 8, in a case in which the remover 221b performs the offset removal operation in response to determining that the preprocessing operation is required based on the level of the offset included in the detection signal from the gyro sensor 210, and the determiner 221a stops the operation of the filter 222 while the remover 221b performs the offset removal operation and then resumes the operation of the filter 222 after the offset removal operation of the remover 221b is terminated, a time in which the level of the offset included in the output signal of the filter 222 is brought close to ‘0’ is decreased.

As set forth above, according to the examples disclosed herein, a waiting time until an optical image stabilizer may be operated normally at the time of an initial operation may be reduced.

The apparatuses, units, modules, devices, and other components illustrated in FIGS. 3-4 that perform the operations described herein with respect to FIG. 5 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 5 that perform the operations described herein with respect to FIGS. 3 and 4 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD−ROMs, CD−Rs, CD+Rs, CD−RWs, CD+RWs, DVD−ROMs, DVD−Rs, DVD+Rs, DVD−RWs, DVD+RWs, DVD−RAMs, BD−ROMs, BD−Rs, BD−R LTHs, BD−REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A filter preprocessing circuit comprising:
a determiner configured to determine, depending on a level of an offset included in a detection signal from a gyro sensor, whether or not a preprocessing operation is to be performed before the detection signal is transferred to a filter; and
a remover configured to remove a portion of the offset from the detection signal during the preprocessing operation.

2. The filter preprocessing circuit of claim 1, wherein the determiner is configured to determine whether or not the preprocessing operation is to be performed, depending on an average offset level of the detection signal.

3. The filter preprocessing circuit of claim 2, wherein the determiner is configured to determine whether or not the preprocessing operation is to be performed, depending on the average offset level during a time which is set according to a set sampling rate.

4. The filter preprocessing circuit of claim 1, further comprising an operation controller configured to control whether or not the filter is to be operated, depending on a determination of whether the preprocessing operation is being performed.

5. The filter preprocessing circuit of claim 4, wherein the operation controller is configured to stop operation of the filter while the remover removes the portion of the offset, and the operation controller is configured to resume the operation of the filter when the remover finishes removing the portion of the offset.

6. An optical image stabilization module comprising:
a gyro sensor configured to detect motion;
a detection signal processor configured to
determine, depending on a level of an offset included in a detection signal from the gyro sensor, whether or not a preprocessing operation is to be performed before filtering the offset of the detection signal, and
process a signal obtained by filtering the detection signal to output the processed signal;
an imager configured to capture an image; and
an optical path controller configured to control an optical path of the imager according to an output signal of the detection signal processor.

7. The optical image stabilization module of claim 6, wherein the detection signal processor comprises:
a filter preprocessing circuit configured to perform the preprocessing operation depending on the level of the offset included in the detection signal from the gyro sensor, before filtering the offset of the detection signal;
a filter configured to filter an offset of a signal transferred from the filter preprocessing circuit; and
a signal processing processor configured to process the filtered signal and transfer the processed filtered signal to the optical path controller.

8. The optical image stabilization module of claim 7, wherein the filter preprocessing circuit comprises:
a determiner configured to determine whether or not the preprocessing operation is to be performed depending on the level of the offset included in the detection signal;
a remover configured to remove a portion of the offset from the detection signal according to the determining of whether or not the preprocessing operation is to be performed; and
an operation controller configured to control whether or not the filter is operated depending on a determination of whether the preprocessing operation is being performed.

9. The optical image stabilization module of claim 8, wherein the determiner is configured to determine whether or not the preprocessing operation is to be performed, depending on an average offset level of the detection signal.

10. The optical image stabilization module of claim 9, wherein the determiner is configured to determine whether or not the preprocessing operation is to be performed, depending on the average offset level during a time which is set according to a set sampling rate.

11. The optical image stabilization module of claim 8, wherein the operation controller is configured to stop operation of the filter while the remover removes the portion of the offset, and the operation controller is configured to resume the operation of the filter when the remover finishes removing the portion of the offset.

12. A method of performing optical image stabilization, comprising:
determining, at a determiner, a level of an offset in a detection signal received from a gyro sensor;
in response to determining that the level of the offset is greater than or equal to a reference level, removing, at a remover, an amount of the offset from the detection signal;
filtering, at a filter, a remaining offset in the detection signal having the amount of the offset removed; and
controlling, at an optical path controller, an optical path of an imager based on the filtered detection signal in order to correct for shaking of a device associated with the gyro sensor.

13. The method of claim 12, further comprising:
stopping operation of the filter while the remover removes the amount of the offset; and
resuming the operation of the filter when the remover finishes removing the amount of the offset.
